(19) United States
(12) Patent Application Publication
(10) Pub. No.: US 2009/0052010 A1
(43) Pub. Date: Feb. 26, 2009

(54) Apparatus for providing multiple independently controllable beams from a single laser output beam and delivering the multiple beams via optical fibers

(76) Inventors: Raymond Michaud, Lebanon, CT (US); Eric R. Mueller, West Suffield, CT (US)

Correspondence Address: STALLMAN & POLLOCK LLP, 353 SACRAMENTO STREET, SUITE 2200, SAN FRANCISCO, CA, 94111, US

(21) Appl. No.: 11/895,248

(22) Filed: Aug. 23, 2007

(51) Int. Cl. G02F 1/29; G02B 27/10

(52) U.S. Cl. 359/315; 359/618

(57) ABSTRACT

An output beam from a laser is directed into an acousto-optic cell. The acousto-optic cell is driven by RF voltages at four different frequencies. A portion of the laser output beam is diffracted by the acousto-optic cell at four different angles to the laser output beam. This provides four secondary beams. The magnitude of the RF voltages applied to the acousto-optic cell and the power in the laser output beam may be cooperatively varied to provide a predetermined power in each of the secondary beams. The four secondary beams are directed into four beam separating optical fibers connected to four transport optical fibers for transporting the secondary beams to a location remote from the laser. Power in the beams is monitored at the output ends of the four optical fibers for controlling the magnitude of the RF voltages. All four beams are focused into the beam-separating fibers by a single lens.

### TECHNICAL FIELD OF THE INVENTION

The present invention relates generally to dividing a single laser output beam into a plurality of beams. The invention relates in particular to dividing an output beam from a CO₂ laser into a plurality of beams and directing the plurality of beams into a corresponding plurality of optical fibers.

### DISCUSSION OF BACKGROUND ART

Laser applications often require a work piece to be irradiated simultaneously with two or more individually controlled laser beams. Prior art methods of providing such a plurality of individually controlled laser beams have involved the use of arrays of beamsplitters including polarization-sensitive beamsplitters and polarization rotators. Using such beam splitter arrays together with separate modulators or controllers, while less costly than using a separate lasers for each required laser beam, may still prove prohibitively expensive, depending on a particular application.

Another method involves dividing a beam using an acousto-optic deflector powered at a number of different frequencies equal to the number of beams desired. This method is described in U.S. Pat. No. 7,003,003 assigned to the assignee of the present invention and the complete disclosure of which is hereby incorporated by reference. An abbreviated description of the method disclosed in the '003 patent is set forth below with reference to FIG. 1.

FIG. 1 schematically depicts beam-dividing apparatus 10 in which there are laser beam paths and connections between electronic and electrical components. Beam paths are depicted by fine lines, and electrical connections are depicted by bold lines. Apparatus 10 includes a carbon dioxide laser CO₂ laser 12 including an RF power supply (not shown). A CO₂ laser can provide an output beam having a wavelength between about 9 and 11 micrometers (μm). A controller 14 controls the output power of the laser and commands the RF power supply to operate the laser in a selected mode such as continuous wave (CW) or pulsed mode. Laser 10 delivers an output beam 16. Beam 16 is directed by turning mirrors 18 and 20 into an acousto-optic cell 22. One preferred acousto-optic cell is a model AGD-406 available from IntraAction Corporation of Bellwood, Ill. Such an AO cell is generally referred to as a broadband AO cell. Broadband AO cells are designed to maintain the Bragg relationship (see below) over the entire bandwidth of the device. This allows the cell to be simultaneously driven at a plurality of different RF frequencies and provides minimal variation of the diffraction intensity, for example, less than about 10%, across a wide range of possible diffraction angles.

In apparatus 10, AO cell 22 is driven by RF voltages at four different RF frequencies, f₁, f₂, f₃, and f₄, within the bandwidth of the AO cell. Each driving frequency deflects a portion of output beam 16 at a particular angle depending on the frequency. The power in each diffracted portion (diffracted beam or secondary beam) is dependent, inter alia, on the power in beam 16 and the magnitude of the driving frequency, i.e., the magnitude of the RF voltage at that driving frequency. The diffraction angle (the Bragg angle) is given by the Bragg relationship:

Sin θ_{Bn}=λ₀fₙ/2N₀Vₐ (1)

where θ_{Bn} is the Bragg angle for frequency fₙ, fₙ is the driving frequency; λ₀ is the laser beam wavelength; N₀ is the refractive index of the acousto-optic cell material at wavelength λ₀; and Vₐ is the acoustic velocity in the cell material. In this example, the diffracting material of the cell is germanium (Ge), which is transparent for output wavelengths of the CO₂ laser. Those skilled in the art will recognize that other laser wavelengths may require a cell having a different diffracting material.

Acoustic waves propagated in the acousto-optic material of the AO-cell by the driving frequencies generate optical phase gratings (not shown) within the acousto-optic material, through which laser output beam 16 passes. The angular (frequency) resolution of AO cell depends, inter alia, on the size of beam 16 at the AO cell and the driving frequencies. Beam-size is adjustable by a telescope or beam expander 24. Alternatively, the driving frequencies can be varied, to increase or decrease the spacing of the phase gratings.

In apparatus 10, driving frequencies for the acousto-optic cell are generated by four individual RF oscillators, designated f₁, f₂, f₃, and f₄ corresponding to the frequencies that are generated thereby. The RF voltage outputs of oscillators f₁, f₂, f₃, and f₄ are amplified by variable gain amplifiers A₁, A₂, A₃, and A₄, respectively.

Driving AO cell 22 with four frequencies provides four diffracted beams designated B₁, B₂, B₃, and B₄ corresponding to the driving frequencies. An undiffracted portion 16R of beam 16 is absorbed by a beam dump 26. The diffracted beams are directed by turning mirrors 27 and 28 into a folded optical path that is long enough to achieve a desired spatial separation of the beams. Once the beam separation is adequate, the beams can be focused by lenses 30 directly onto a workpiece. A beamsplitter 32 directs a sample of each beam to an individual detector to provide a measure of power in the beam. The samples are designated S₁, S₂, S₃, and S₄ corresponding to beams B₁, B₂, B₃, and B₄. Detectors are designated D₁, D₂, D₃, and D₄ corresponding to beams B₁, B₂, B₃, and B₄.

The detectors and associated circuitry 34 monitor power of each of the diffracted beams. The detector outputs are compared by a processor 36 against four input reference voltage signals provided by processor 36 in response to commands C₁, C₂, C₃, and C₄, corresponding to beams B₁, B₂, B₃, and B₄. The commands provided to the processor establish the desired amount of optical power in each of the beams. The reference voltage signals are representative of that desired power. Comparison of the reference voltages and the detector outputs provides gain commands G₁, G₂, G₃, and G₄ to amplifiers A₁, A₂, A₃, and A₄ respectively. The gain commands provide that the amplifiers increase or decrease the power of driving frequencies f₁, f₂, f₃, and f₄. There are, in effect, four control loops designated L₁, L₂, L₃, and L₄ corresponding to the four beams B₁, B₂, B₃, and B₄, respectively. The amplitude of each of the four beams B₁, B₂, B₃, and B₄ can be independently adjusted by varying the gain and accordingly the RF output voltage of amplifiers A₁, A₂, A₃ and A₄ respectively.

When the power of one of beams B₁, B₂, B₃, and B₄ is changed, absent any other action, power in the other beams will change because all of the beams share a common input (beam 16). This can be defined as a cross coupling between the beams. By way of example, if a voltage at one driving frequency is increased to diffract more light out laser beam 16 into a corresponding secondary beam, then power in the other three beams will be correspondingly reduced. An effect of this is that processor 36, particularly if control loops L₁, L₂, L₃, and L₄ all have about the same bandwidth, can attempt to restore power to the other beams, thereby causing power in one or more of the beams to oscillate. One method of avoiding this oscillation is to program controller 36 such that if a change in power in one the beams is requested, processor 36 suspends control of the other beams, thereby avoiding a competition between the beams for available power. This method, of course, restricts controlled operation of the four beams to applications in which the beams are not required to be simultaneously controlled.

Controlling beams B₁, B₂, B₃, and B₄ compensates for the above-described cross coupling, in a way that will allow the beams to be simultaneously controlled, can be accomplished by cooperatively controlling the power in laser output beam 16. The output power of an RF excited CO₂ laser, as exemplified here, can be conveniently controlled by pulse width modulating (PWM) at a constant repetition rate or by pulse repetition frequency (PRF) modulating the input RF power into the discharge at a constant pulse width. Processor 36 can be programmed to keep track of the total power required by all four beams and to command controller 14 via another control loop L₅ to raise or lower the power in output beam 16 in response to a requested change in power, in one or more of beams B₁, B₂, B₃, and B₄. This allows the beams to be controlled simultaneously.

A deficiency of the above described apparatus is that it must be located close to a workpiece to facilitate beam-delivery. There is a need for an effective way of transporting a plurality of beams from the apparatus of FIG. 1 for treating a workpiece at a location remote from the apparatus.

### SUMMARY OF THE INVENTION

In one aspect of the present invention laser apparatus comprises a laser providing an output beam. An arrangement is provided for dividing at least a portion of said output beam into a plurality N of secondary beams. The apparatus includes a plurality N of optical fibers, each thereof having a distal end and a proximal end. A supporting arrangement is provided the optical fibers. The optical fibers are constrained, laterally spaced apart, by the supporting arrangement with the distal ends of the optical fibers being spaced apart by a distance greater than the distance by which the proximal ends thereof are spaced apart. A single lens is arranged to focus the plurality of secondary beams into the proximal ends of the plurality of first optical fibers.

In another aspect of the present invention laser apparatus comprises a CO2 laser providing an output beam having a wavelength greater than about 9 micrometers. An arrangement is provided for dividing at least a portion of the output beam into a plurality N of secondary beams. A beam-power control arrangement is provided for independently varying the power in each of the secondary beams. The apparatus includes a plurality N of hollow-core optical fibers, each thereof having a distal end and a proximal end. An arrangement is provided for directing the plurality of secondary beams into the proximal ends of the plurality of optical fibers, such that said beams exit said optical fibers at the distal ends thereof. A plurality N of detectors is arranged to sample the N secondary beams exiting the N optical fibers, the detectors are cooperative with the beam-power control arrangement for providing a predetermined power in each of the secondary beams exiting the optical hollow-core fibers.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 schematically illustrates a prior-art apparatus for dividing a beam from a CO₂ laser into a plurality of beams, the power in each of which is separately controllable.

FIG. 2 schematically illustrates a modification of the apparatus of FIG. 1 for transporting the plurality of beams via a corresponding plurality of hollow-core fibers to a location remote from the apparatus.

### DETAILED DESCRIPTION OF THE INVENTION

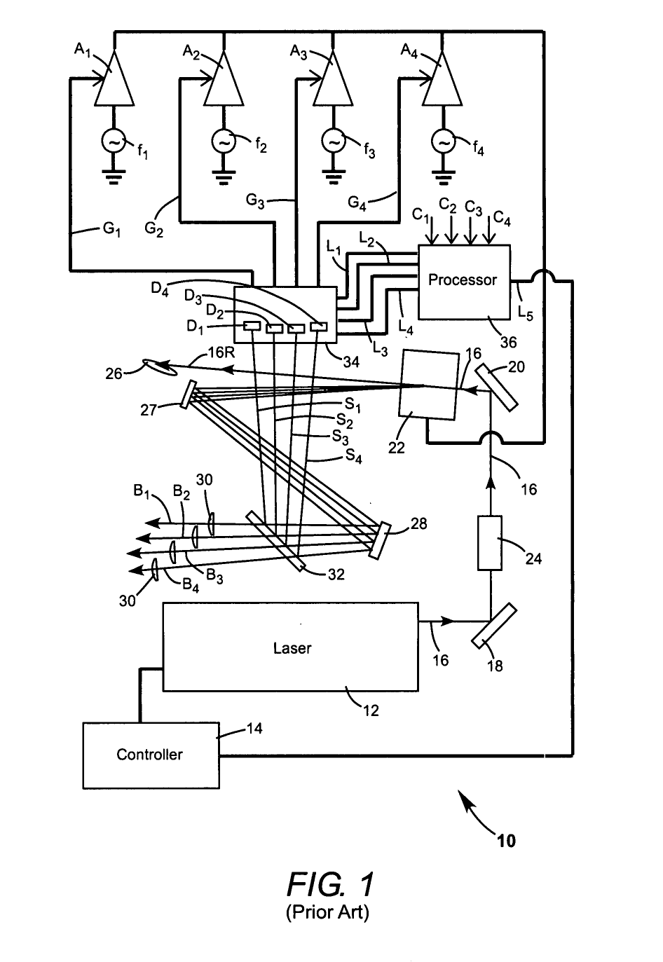

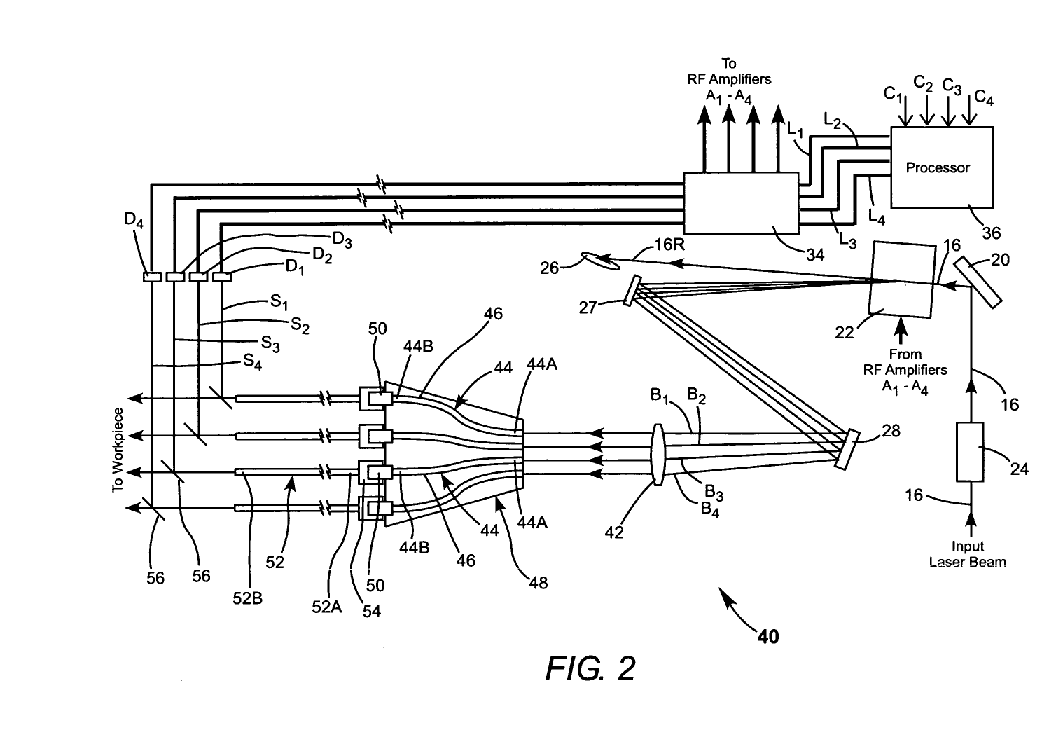

Apparatus in accordance with the present invention is described in terms of a modification of above-described beam dividing apparatus 10 of FIG. 1. The inventive apparatus 40 is depicted in FIG. 2 wherein like components are designated by like reference numerals. Only differences between and additions to apparatus 10 are described to avoid repetition. Only sufficient detail of the beam-dividing portion of the inventive apparatus is depicted to highlight details of the modification.

In apparatus 40 beamsplitter 32 of apparatus 10 has been removed. Individual focusing lenses 32 of apparatus 10 are replaced in apparatus 40 by a single lens 42. The focal length of the lens is selected, cooperative with the optical path distance from the lens from the AO cell 22, such that diverging beams B1, B2, B3, and B4 propagate parallel to each other. In addition, the lens focuses the beams to a beam waist position at which are arranged proximal ends 44A of optical fibers 44. The spacing of the proximal ends corresponds to the spacing of the beams such that each beam is focused into a corresponding one of the optical fibers.

It should be noted that the term “single lens” as used in this description and the appended claims means only that one lens focuses all secondary beams into the optical fibers. The lens itself, while depicted in FIG. 2 as only a single optical element, may include two or more elements for aberration correction, as is known in the art.

Hollow core optical fibers 44 are held in grooves 46 in a support platform 48. Platform 48 is preferably made from aluminum, but can be made from other metallic materials or from dielectric materials. Fibers 44 can be referred to functionally as beam-spreading or beam-separating fibers. Fibers 44 are curved such that distal ends 44B thereof are separated from each other by a distance greater than proximal ends thereof are separated from each other. The distal ends are preferably separated from each other sufficiently to allow a male fiber connector 50 to be attached to each one, leaving sufficient space that a female connector can be easily attached to each one of the male connectors., as discussed below. The hollow core is required because of the long wavelength, for example greater than about 9.0 micrometers (μm) of radiation in the beam.

Hollow-core optical fibers 52 are provided for transporting the beams from the spreading fibers to the remote location of the workpiece (not shown). Proximal end 52A of each fiber has a female connector 54 thereon for attaching the fiber to male connector 50 of the corresponding spreading fiber. Beams are delivered from distal ends 52B of fibers 52 to the workpiece. Beamsplitters 56 send samples S₁, S₂, S₃, and S₄, one for each beam, to detectors D₁, D₂, D₃, and D₄ respectively. The detectors are cooperative with monitoring circuitry 34 as described above with reference to apparatus 10 of FIG. 1.

It is particularly important in the arrangement of the present invention that beam-power be monitored after leaving the transport fibers as depicted in FIG. 2 and not at the output of AO cell 22 as is the case in apparatus 10 of FIG. 1. A reason for this is as follows.

Unlike solid-core fibers used for transporting radiation at wavelengths from the ultraviolet (UV) through the near infrared (NIR), hollow-core fibers are particularly susceptible to losses at curves in the fibers and relatively small changes in the curvature, even changes occasioned by vibration, can cause a significant change in loss. While the spreading fibers 44 can be maintained in a fixed curvature by grooves 46 in block 48, it will usually not be practical to constrain transport fibers 52 to prevent small changes in curvature. Accordingly, as it is important that power of the beams on the workpiece is controlled, it is important that power monitoring for control purposes occurs after each beam leaves distal end 52B of the corresponding transport fiber 52.

The present invention is described above in terms of a preferred embodiment. The invention, however, is not limited to the embodiment described and depicted herein. Rather the invention is limited only to the claims appended hereto.

What is claimed is:

1. Apparatus comprising:
a laser providing an output beam;
an arrangement for dividing at least a portion of said output beam into a plurality N of secondary beams, propagating laterally spaced apart from each other;
a plurality N of first optical fibers, each thereof having a distal end and a proximal end;
a supporting arrangement for said first optical fibers, said first optical fibers being constrained, laterally spaced apart, on said supporting arrangement with said the distal ends of said optical fibers being spaced apart by a distance greater than the distance by which the proximal ends are spaced apart; and
a single lens arranged to focus said plurality of secondary beams into the proximal ends of said plurality of first optical fibers.

2. The apparatus of claim 1, wherein the laser is a CO₂ laser having a wavelength greater than about 9 micrometers and the optical fibers are hollow core optical fibers.

3. The apparatus of claim 1, wherein said supporting arrangement is a platform and said optical fibers are constrained in grooves in said platform.

4. The apparatus of claim 1, wherein the proximal ends of said first optical fibers are spaced apart from other by about the same distance as said secondary beams are spaced apart from each other.

5. The apparatus of claim 1, further including a plurality N of second optical fibers, with proximal ends of said second optical fibers being connected to the distal ends of said first optical fibers for transporting said secondary beams to a locate remote from said laser.

6. The apparatus of claim 5, wherein the apparatus includes a beam-power control arrangement for independently varying the power in each of said secondary beams, and wherein there is a plurality N of detectors arranged to sample said N secondary beams exiting distal ends of said N second optical fibers, said detectors being cooperative with said beam-power control arrangement for maintaining a predetermined power in said secondary beams exiting said second optical fibers.

7. Apparatus comprising:
a CO₂ laser providing an output beam having a wavelength, greater than about 9 micrometers;
an arrangement for dividing at least a portion of said output beam into a plurality N of secondary beams;
a beam-power control arrangement for independently varying the power in each of said secondary beams;
a plurality N of hollow-core beam-transport optical fibers, each thereof having a distal end and a proximal end;
an arrangement for directing said plurality of secondary beams into the proximal ends of said plurality of beam-transport optical fibers, such that said beams exit said beam-transport optical fibers at said distal ends thereof; and
a plurality N of detectors arranged to sample said N secondary beams exiting said N beam-transport optical fibers, said detectors being cooperative with said beam-power control arrangement for maintaining a predetermined power in said secondary beams exiting said beam-transport optical fibers.

8. The apparatus of claim 7, wherein said secondary-beam directing arrangement includes a plurality N of beam-spacing hollow-core optical fibers, said beam-spacing optical fibers being constrained, laterally spaced apart, on a supporting arrangement with said the distal ends of said beam-spacing optical fibers being spaced apart by a distance greater than the distance by which the proximal ends thereof are spaced apart.

9. The apparatus of claim 8, wherein said secondary-beam directing arrangement includes a single lens arranged to focus said N secondary beams from said output-beam dividing arrangement into the proximal ends of said beam-spacing optical fibers.

10. The apparatus of claim 8, wherein said supporting arrangement is a platform and said optical fibers are constrained in grooves in said platform.

11. Apparatus comprising:
a laser providing an output beam;
an acousto-optic cell arranged to receive said output beam;
a plurality of RF oscillators, the output of each of which is amplified by a corresponding plurality of variable gain amplifiers, the output of said amplifiers being arranged to drive said acousto-optic cell simultaneously at a corresponding plurality of different RF frequencies thereby causing a portion of said laser output beam to be diffracted by said acousto-optic cell into a corresponding plurality of separate secondary beams propagating at an angle to each other, with the power in each of said secondary beams being monitored via a corresponding plurality of detectors, and the power in each of said secondary beams depending on the magnitude of said RF driving frequencies and the power in said laser output beam;
electronic circuitry arranged to vary the power in said laser beam cooperatively with varying the gain of said amplifiers and correspondingly varying the magnitude of said driving frequencies and monitoring of power in said secondary beams for maintaining a predetermined power in each of said secondary beams;
an arrangement for directing said plurality of secondary beams into proximal ends of a corresponding plurality of optical fibers for transport to a location remote from said laser; and
an arrangement at the distal ends of said optical fibers for directing a sample of each of said secondary beams to said detectors for said power monitoring.

12. Apparatus comprising:
a laser providing an output beam;
an acousto-optic cell arranged to receive said output beam;
a plurality of RF oscillators, the output of each of which is amplified by a corresponding plurality of variable gain amplifiers, the output of said amplifiers being arranged to drive said acousto-optic cell simultaneously at a corresponding plurality of different RF frequencies thereby causing a portion of said laser output beam to be diffracted by said acousto-optic cell into a corresponding plurality of separate secondary beams propagating at an angle to each other, with the power in each of said secondary beams being monitored via a corresponding plurality of detectors, and the power in each of said secondary beams depending on the magnitude of said RF driving frequencies and the power in said laser output beam;
electronic circuitry arranged to vary the power in said laser beam cooperatively with varying the gain of said amplifiers and correspondingly varying the magnitude of said driving frequencies and monitoring of power in said secondary beams for maintaining a predetermined power in each of said secondary beams; and
a single lens arranged to focus said plurality of secondary beams into proximal ends of a corresponding plurality of optical fibers, said optical fibers being constrained on a support arrangement with said proximal ends thereof being spaced apart from each other by a distance less than the distal ends thereof are spaced apart from each other.
